(19) United States
(12) Patent Application Publication
(10) Pub. No.: US 2026/0219643 A1
(43) Pub. Date: Jul. 30, 2026

(54) DRIVE CIRCUITRY FOR DC SYSTEMS

(71) Applicant: SIGNIFY HOLDING B.V., EINDHOVEN (NL)

(72) Inventor: TAWATOS PHADUNGSOONDARARAK, MEMPHIS, TN (US)

(21) Appl. No.: 19/157,398

(22) PCT Filed: Feb. 12, 2024
(86) PCT No.: PCT/EP2024/053410

§ 371 Date: Aug. 18, 2025

Related U.S. Application Data
(60) Provisional application No. 63/446,984, filed on Feb. 20, 2023.

(30) Foreign Application Priority Data
Apr. 4, 2023 (EP) 23166571.2

(51) Int. Cl. G05B 19/042

(52) U.S. Cl. CPC G05B 19/042; G05B 2219/25257

(57) ABSTRACT

A driver circuit, including a microcontroller and an output signal generator is provided. The microcontroller generates a startup control signal received by the startup control signal. The output signal generator provides, in response to receiving the startup control signal, a startup output signal to a load. The startup output signal is based on a DC power signal provided by a DC power source. The load may be a TLED luminaire. The startup output signal may be a sinusoidal or square waveform. The microcontroller receives a feedback signal corresponding to the load. The microcontroller generates, in response to receiving the feedback signal, a drive control signal. The output signal generator receives the drive control signal and provides, in response to receiving the drive control signal, a drive output signal, such as a DC signal, to the load. The drive output signal is based on the DC power signal.

### FIELD OF THE DISCLOSURE

The present disclosure is directed generally to power control systems and, more specifically, to drive circuitry for direct current (DC) systems and to methods of controlling a power-controlled load, i.e., a lighting apparatus, from a power source.

### BACKGROUND

Tubular light emitting diode (TLED) luminaires are often used to replace fluorescent tubular luminaires. Type A TLED luminaires are configured to be connected to a fixture having a ballast as a direct, “plug and play” replacement for a fluorescent tubular luminaire. Type B TLED luminaires are configured to be connected to an alternating current (AC) power supply input. Type B TLED luminaires are configured to directly couple to an AC mains power supply in a residential or commercial building, for example, bypassing ballast circuitry. Type B TLED luminaires include internal circuitry, i.e., a switch, configured to convert the AC mains power to DC power to properly supply power to one or more LEDs in the luminaire. This internal circuitry initially verifies whether the input to the Type B TLED luminaire is AC power or not before allowing converted power to drive the TLED luminaire, i.e., by turning on an internal switch. If DC power is being supplied at the verification step, the LEDs of the Type B TLED luminaire will not be allowed to illuminate. However, some applications require installed luminaires to run on DC power, such as emergency lighting applications, recreational vehicles, or portable or mobile lamps.

In these applications, DC power may be supplied by a back-up battery or other DC power source. Accordingly, Type B TLED luminaires would be unable to be used in such applications, unless the DC power was converted to AC power, such as by using a DC to AC inverter. These inverters are typically expensive, large in size, and generate significant electromagnetic interference. Accordingly, there is a need in the art for improved systems and methods for driving Type B TLED luminaires which require an AC power connection in DC system applications.

### SUMMARY OF THE DISCLOSURE

The present disclosure is directed generally to power control systems and, more specifically, to drive circuitry for direct current (DC) system applications and methods of controlling a power-controlled load, i.e., a lighting apparatus, from a power source. The startup circuitry broadly includes a microcontroller and an output signal generator. The microcontroller and the output signal generator are each powered by a DC power source, such as an emergency back-up battery. Upon activation, the microcontroller configures the output signal generator to generate a startup output signal based on the DC power provided by the DC power source. The startup output signal is then provided to a load, such as a Type B tube light-emitting diode (TLED) luminaire, expecting a certain type of signal, such as an AC signal or a pulsed DC signal. Upon the load receiving the start-up output signal and a current sensor verifying that the load has begun accepting current to drive its components, the microcontroller then reconfigures the output signal generator to generate a drive output signal based on the DC power signal. This drive output signal is then used to drive the load. The drive output signal may be a DC signal or an AC signal depending on the type of voltage required to power the components of the load. In the example of the Type B TLED luminaire, the drive output signal may be a DC signal.

The output signal generator may use any combination of components to generate and/or provide the startup and drive output signals. In one example, one or more switches, such as relay switches, and/or transistors, such as metal-oxide-semiconductor field-effect transistors (MOSFETs) or bipolar junction transistors (BJTs), are used to generate the startup output signal. Other types of switching devices may be used. The switches and/or transistors may be arranged in an amplifier configuration, such as an analog Type-AB amplifier. The switches and/or transistors may cause the startup output signal to oscillate at any appropriate frequency, such as 50 or 60 Hz. If the generated startup output signal or the drive output signal is an AC square wave or pulsed DC signal, the switching components of the output signal generator may be configured as switches. Similarly, if the generated startup output signal or the drive output signal is an AC sine wave or AC triangle wave, the switching components of the output signal generator may be transistors (MOSFETs, BJTs, etc.) operating in linear mode.

The voltage levels of the peak of the startup output signal and the drive output signal may be the same or different depending on the application. In one example, the output signal generator may provide a low voltage startup output signal to the load during startup, and then drive the load with a high voltage DC power signal (such as 200 V). The increase in voltage may be achieved using a step-up DC-to-DC converter.

The feedback signal provided to the microcontroller may be generated by a current sensor, which may include a current sensing resistor. In some examples, the current sensor is an aspect of the luminaire start-up circuitry, external to the load. In other examples, the current sensor may be embedded within the load itself, and electrically coupled to the microcontroller. In some examples, the current sensor is integrated with and part of the microcontroller or output signal generator. The current sensor provides the microcontroller with the feedback signal indicative of the load detecting the startup output signal in startup mode and switching to drive mode.

Generally, in one aspect, a driver circuit is provided. The driver circuit may include a microcontroller. The microcontroller is configured to generate a startup control signal. The microcontroller may be configured to generate the startup control signal upon activation.

The driver circuit further includes an output signal generator. The output signal generator is configured to receive the startup control signal.

The output signal generator may be further configured to provide, in response to receiving the startup control signal, a startup output signal to a load. The startup output signal is based on a DC power signal provided by a DC power source. According to an example, the load may be a lighting device. The lighting device may be a TLED luminaire. According to an example, the DC power source may be a battery. The startup output signal may be a sinusoidal waveform, a square waveform, or a triangular waveform.

The microcontroller is further configured to receive a feedback signal. The feedback signal corresponds to the load.

The microcontroller is further configured to generate, in response to receiving the feedback signal, a drive control signal.

The output signal generator is further configured to receive the drive control signal.

The output signal generator is further configured to provide, in response to receiving the drive control signal, a drive output signal to the load. The drive output signal is based on the DC power signal provided by the DC power source.

According to an example, the output signal generator includes a startup signal controller. The startup signal controller is configured to generate an AC control signal in response to receiving the startup control signal. The output signal generate further includes a startup step-up DC-to-DC converter. The startup step-up DC-to-DC converter is configured to generate a startup power signal based on the DC power signal. The output signal generator further includes a startup signal generator. The startup signal generator is configured to generate, in response to receiving the AC control signal, the startup output signal based on the startup power signal. The startup signal generator may include one or more switches or transistors. The startup signal generator may be an analog type-AB amplifier.

According to an example, the output signal generator further includes a drive signal controller. The drive signal controller is configured to generate a DC control signal in response to receiving the drive control signal. The output signal generator further includes a drive step-up DC-to-DC converter, The drive step-up DC-to-DC converter is configured to generate a drive power signal based on the startup power signal. The output signal generator further includes a drive signal generator. The drive signal generator is configured to provide, in response to receiving the DC control signal, the drive output signal. The drive output signal corresponds to the drive power signal. The drive signal generator may be a switch or a transistor.

According to an example, the output signal generator further includes an output signal controller. The output signal controller is configured generate an AC control signal in response to receiving the startup control signal. The output signal generator further includes an output step-up DC-to-DC converter. The output step-up DC-to-DC converter is configured to generate an output power signal based on the DC power signal. The output signal generator further includes a universal signal generator. The universal signal generator is configured to generate, in response to receiving the AC control signal, the startup output signal based on the output power signal. The output signal controller may be further configured to generate a DC control signal in response to receiving the drive control signal.

The universal signal generator may be further configured to generate, in response to receiving the DC control signal, the drive output signal based on the output power signal.

According to an example, the startup output signal may be an AC signal, and the drive output signal is a DC signal.

Generally, in another aspect, a method for driving a load is provided. The method includes generating, via a microcontroller, a startup control signal.

The method further includes receiving, via an output signal generator, the startup control signal.

The method further includes providing, via the output signal generator, a startup output signal to a load in response to receiving the startup control signal. The startup output signal is based on a DC power signal provided by a DC power source.

The method further includes receiving, via the microcontroller, a feedback signal corresponding to the load.

The method further includes generating, via the microcontroller, in response to receiving the feedback signal, a drive control signal.

The method further includes receiving, via the output signal generator, the drive control signal.

The method further includes providing, via the output signal generator, a drive output signal to the load in response to receiving the drive control signal. The drive output signal is based on the DC power signal provided by the DC power source.

In various implementations, a processor or controller can be associated with one or more storage media (generically referred to herein as “memory,” e.g., volatile and non-volatile computer memory such as ROM, RAM, PROM, EPROM, and EEPROM, floppy disks, compact disks, optical disks, magnetic tape, Flash, OTP-ROM, SSD, HDD, etc.). In some implementations, the storage media can be encoded with one or more programs that, when executed on one or more processors and/or controllers, perform at least some of the functions discussed herein. Various storage media can be fixed within a processor or controller or can be transportable, such that the one or more programs stored thereon can be loaded into a processor or controller so as to implement various aspects as discussed herein. The terms “program” or “computer program” are used herein in a generic sense to refer to any type of computer code (e.g., software, firmware, or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is an abstracted schematic of a driver circuit, according to aspects of the present disclosure.

FIG. 2 is a driver circuit including a startup signal generator and a drive signal generator, according to aspects of the present disclosure.

FIG. 3 is a variation of the driver circuit of FIG. 2 wherein the startup signal generator and the drive signal generator include switches, according to aspects of the present disclosure.

FIG. 4 is a variation of the driver circuit of FIG. 2 wherein the startup signal generator and the drive signal generator include transistors, according to aspects of the present disclosure.

FIG. 5 is a two-switch variation of the driver circuit of FIG. 3, according to aspects of the present disclosure.

FIG. 6 is a switch timing diagram showing the variation of output voltage over time of the driver circuits shown in FIGS. 3-5, according to aspects of the present disclosure.

FIG. 7 is a square-wave variation of the switch timing diagram of FIG. 6, according to aspects of the present disclosure.

FIG. 8 is a one-switch variation of the driver circuit of FIG. 3, according to aspects of the present disclosure.

FIG. 9A is a switch timing diagram showing the variation of output voltage over time of the driver circuit shown in FIG. 8, according to aspects of the present disclosure.

FIG. 9B is a square-wave variation of the switch timing diagram of FIG. 9A, according to aspects of the present disclosure.

FIG. 9C is a further square-wave variation of the switch timing diagram of FIGS. 9A and 9B, according to aspects of the present disclosure.

FIG. 10 is a flowchart of a method for driving a load, according to aspects of the present disclosure.

### DETAILED DESCRIPTION OF EMBODIMENTS

The present disclosure is directed generally to power control systems and, more specifically, to drive circuitry for direct current (DC) system applications and to methods of controlling a power-controlled load, i.e., a lighting apparatus, from a power source. The startup circuitry broadly includes a microcontroller and an output signal generator. The microcontroller and the output signal generator are each powered by a DC power source, such as an emergency back-up battery. Upon activation, the microcontroller configures the output signal generator to generate a startup output signal based on the DC power provided by the DC power source. The startup output signal is then provided to a load, such as a Type B tube light-emitting diode (TLED) luminaire, expecting a certain type of signal, such as an AC signal or a pulsed DC signal. Upon the load receiving the start-up output signal and a current sensor verifying that the load has begun accepting current to drive its components, the microcontroller then reconfigures the output signal generator to generate a drive output signal based on the DC power signal. This drive output signal is then used to drive the load. The drive output signal may be a DC signal or an AC signal depending on the type of voltage required to power the components of the load. In the example of the Type B TLED luminaire, the drive output signal may be a DC signal.

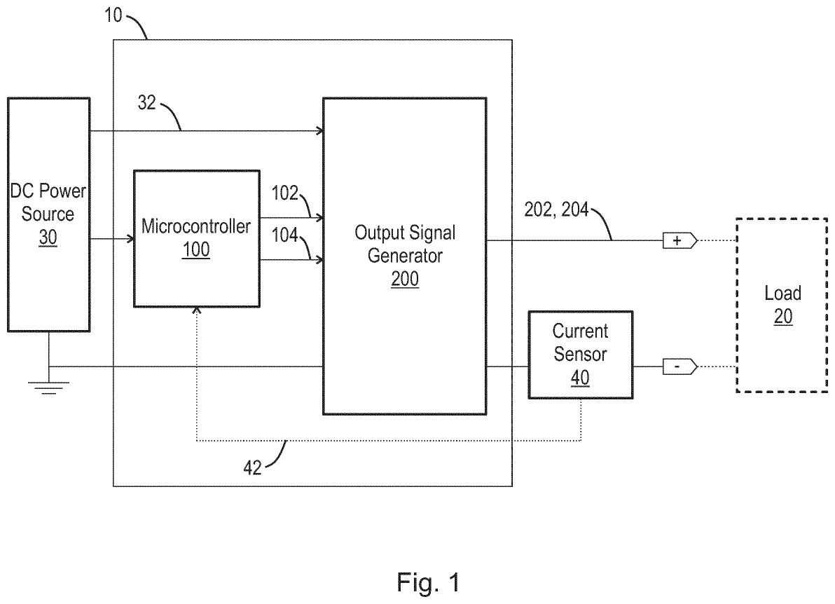

Referring now to the Figures, FIG. 1 is an abstracted schematic of a driver circuit 10. Broadly, the driver circuit 10 includes a microcontroller 100 and an output signal generator 200. The components of the driver circuit 10 are powered by a DC power signal 32 provided by a DC power source 30. In some examples, the DC power source 30 may be a battery as part of an emergency backup system. In other examples, the DC power source 30 may be an aspect of a more complex electrical system, such as an electrical system of an airplane or other vehicle.

The driver circuit 10 is configured to use the DC power signal 32 provided by the DC power source to drive a load 20. In some examples, the driver circuit 10 will be arranged within a fixture external to the load 20. In alternative examples, the driver circuit 10 may be embedded within the load 20. In a preferred, non-limiting example, the load 20 is a Type B TLED luminaire. Type B TLED luminaires are configured to be driven with AC current, such as an AC mains power supply in a residential or commercial building.

Accordingly, Type B TLED luminaires include internal circuitry to convert the AC current to DC current to drive one or more LEDs. This internal circuitry also verifies that the current being supplied to the Type B TLED luminaire is AC current before allowing the supplied current to drive the TLED luminaire. If DC current is being supplied, the LEDs of the Type B TLED luminaire will not illuminate. Accordingly, the driver circuit 10 circumvents this protection by initially providing a startup output signal 202 (in this case, an AC signal) to the load 20. Once the load 20 verifies the presence of the startup output signal 202, the internal circuitry of the load 20 will enable the LEDs to be powered by the received signal. The driver circuit 10 then provides the load 20 with a drive output signal 204, and the LEDs are then powered via DC current.

In other examples, the load 20 may expect to be driven by a DC signal, such as a pulsed DC signal. In these examples, similar to the case described above, the startup output signal 202 is a pulsed DC signal. Once the load 20 verifies the expected DC signal, the driver circuit 10 then provides the load 20 with a drive output signal 204. As with the startup output signal 202, the drive output signal 204 may be any type of signal (such as a non-pulsed DC signal or even an AC signal) depending on the configuration of the load 20.

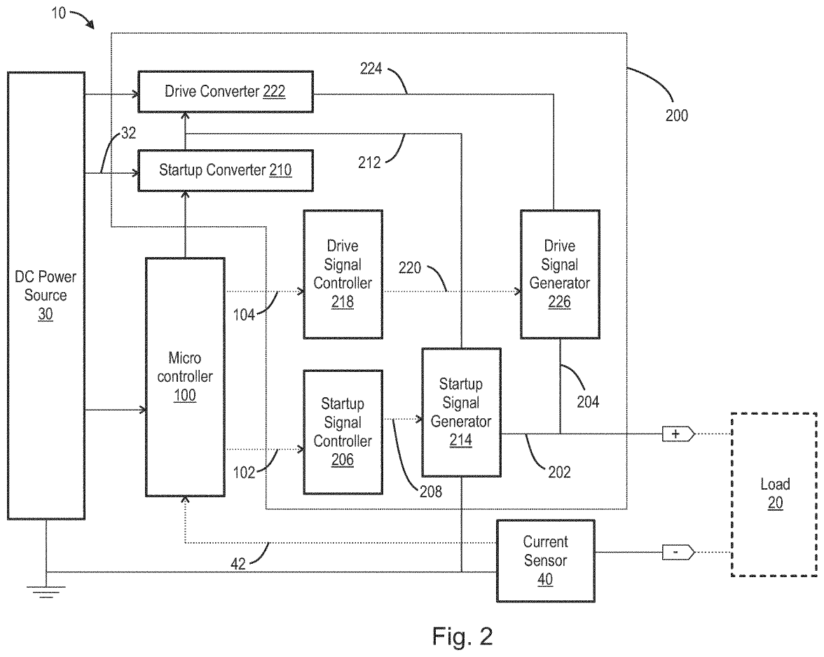

Upon startup, the microcontroller 100 provides a startup control signal 102 to the output signal generator 200. In response to receiving the startup control signal 102, the output signal generator 200 converts the DC supply signal 32 into the startup output signal 202. In some examples, the startup output signal 202 oscillates at a frequency corresponding to a mains supply, such as 50 or 60 Hz. The load 20 receives the startup output signal 202, verifies the presence of AC current, and begins to drive LEDs. The driving of the load 20 is detected by a current sensor 40. In some examples, the current sensor 40 is integrated with and part of driver circuit 10. In some examples, the current sensor 40 includes one or more current sense resistors and/or other components. The current sensor 40 provides a feedback signal 42 to the microcontroller 100. The feedback signal 42 indicates whether or not the load 20 has verified the presence of AC current and begun driving the LEDs. If so, the microcontroller 100 provides the output signal generator 200 with a drive control signal 104. The drive control signal 104 reconfigures the output signal generator 200 to generate a DC power signal 204, thus driving the load 20 with DC current. Accordingly, the driver circuit 10 is able to drive the LEDs of the load 20 via the DC power signal without the use of large and expensive inverters. As will be described in greater detail below, the drive output signal 204 used to drive the load 20 may have a voltage greater than a voltage (such as a peak voltage of an AC signal) of the startup output signal 202. For example, the startup output signal 202 may have a peak voltage of 120 V, while the voltage of the drive output signal may be 200V. FIG. 2 illustrates a more detailed example of the driver circuit 10 of FIG. 1. In particular, FIG. 2 illustrates various aspects of the output signal generator 200, including a startup signal controller 206, a startup step-up DC-to-DC converter 210, a startup signal generator 214, a drive signal controller 218, a drive step-up DC-to-DC converter 222, and a drive signal generator 226. In this non-limiting example, the load 20 is a Type-B TLED luminaire configured to be driven with AC current.

As described above, the microcontroller 100 provides a startup control signal 102 to the startup signal controller 206. Further, the startup step-up DC-to-DC converter 210 generates startup power signal 212. Startup power signal 212 is a voltage-boosted version of DC power signal 32 where the voltage level of the DC power signal 32 is increased to a level appropriate for the verification mode of the load 20. In one example, the voltage level of the DC power signal 32 may be 48 V, while the voltage level of the boosted startup power signal 212 may be 120 V.

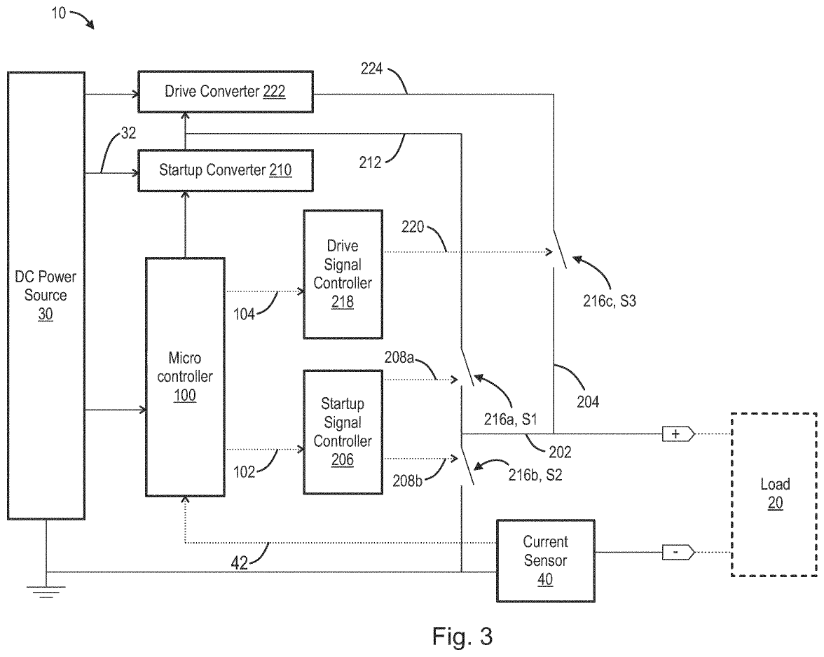

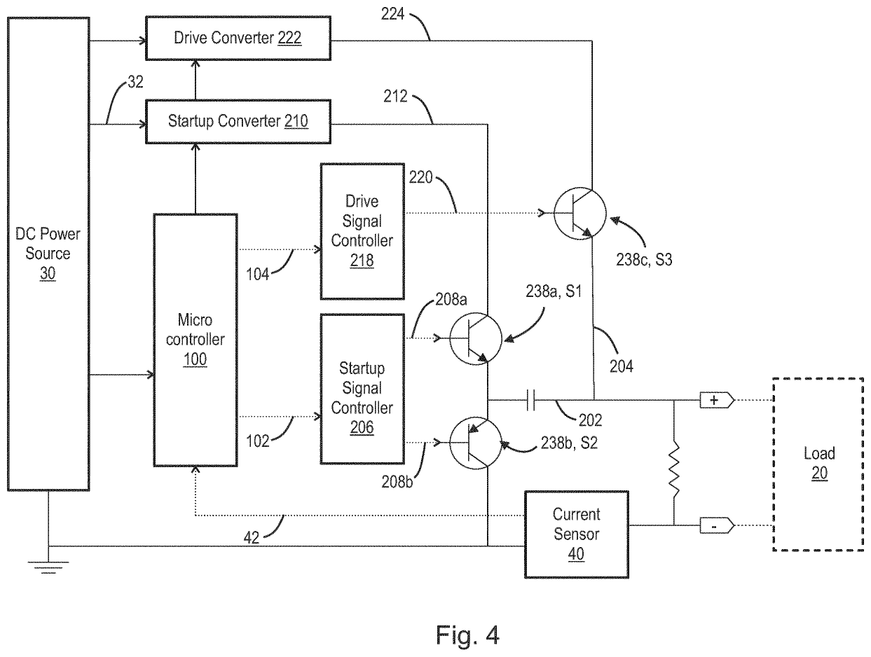

In response to receiving the startup control signal 102, the startup signal controller generates an AC control signal 208. The AC control signal 208 and the startup power signal 212 are provided to the startup signal generator 214. As will be described in greater detail below, the startup signal generator 214 uses one or more switches 216 (see FIG. 3), transistors 238 (see FIG. 4), and/or other components to generate the startup output signal 202. In some non-limiting examples, the switches 216 may be relay switches. The transistors 238 may be metal-oxide-semiconductor field-effect transistors (MOSFETs) or bipolar junction transistors (BJTs) or insulated-gate bipolar transistors (IGBT). The components of the startup signal generator 214 may be gallium nitride (GaN), silicon carbide (SiC), or any other semiconductor device which can function in both linear and saturation modes. In some instances, the transistors 238 may act like switches 216 having distinct on and off states, resulting in AC square waves or DC pulses. In other instances, the transistors 238 may be operated in linear mode, resulting in a sinusoidal or triangular AC signal. The startup output signal 202 (in this case, an AC signal) is then provided to the load 20 for verification of AC current.

Once the load 20 verifies the AC current of the startup output signal 202, the load 20 begins accepting current to drive its components, such as, in the case of Type B TLED luminaires, one or more LEDs. The acceptance of current is detected by current sensor 40, which provides a corresponding feedback signal 42 to the microcontroller 100.

Upon receiving the feedback signal 42 indicating that the load 40 has begun accepting current, the microcontroller 100 generates a drive control signal 104 which is provided to the drive signal controller 218. In response to receiving the drive control signal 104, the drive signal controller 218 generates a DC control signal 220. Simultaneously, the microcontroller 100 may stop providing the startup control signal 102, disabling the startup output signal 202.

The drive step-up DC-to-DC converter 222 generates a drive power signal 224 by boosting the voltage of the startup power signal 212. In one example, the drive power signal 224 may be boosted to a voltage level to 200 V. In other examples, the drive power signal 224 may be boosted to any other appropriate voltage level for the load 20.

The drive signal generator 226 receives the drive power signal 224 from the drive-step-up DC-to-DC converter 222 and the DC control signal 220 from the drive signal controller 218. Upon receiving the DC control signal 220, the drive signal generator 226 provides the drive power signal 224 to the load 20 as the drive output signal 204.

Accordingly, in this non-limiting example, the load 20 will be driven by a high voltage (due to the two step-up converters 210, 222) DC signal. As will be described in greater detail below, the drive signal generator 226 uses one or more switches 216 (see FIG. 3), transistors (see FIG. 4), and/or other components to provide the drive output signal 204 to the load.

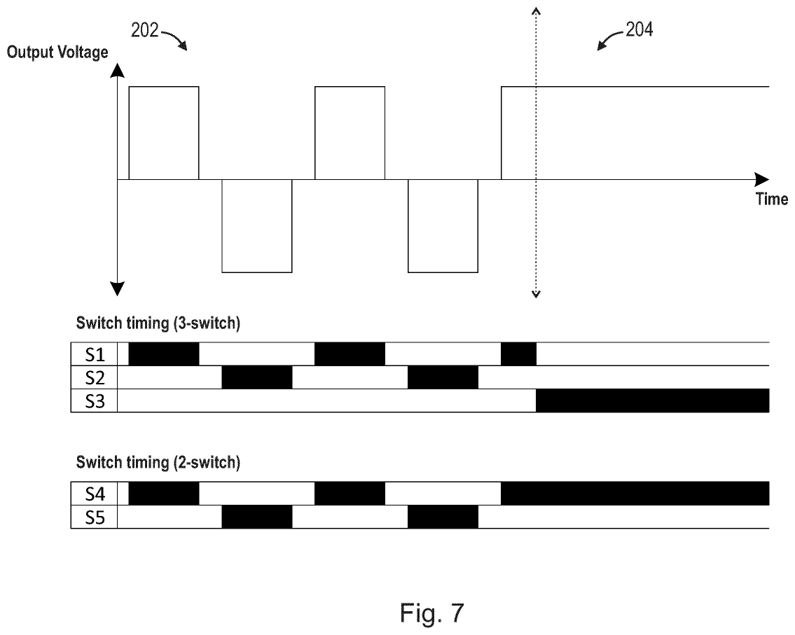

FIG. 3 illustrates an example of the driver circuit 10 where the startup signal generator 214 and the drive signal generator 226 are embodied as a series of switches 216a-c. As will be shown with greater detail in FIG. 7, the startup signal controller 206, in response to receiving the startup control signal 102 from the microcontroller 100, generates a first AC control signal 208a and a second AC control signal 208b. The first AC control signal 208a is used to toggle a first switch (S1) 216a, and the second AC control signal 208b is used to toggle a second switch (S2) 216b. The first switch 216a controls the flow of the startup power signal 212 to the load 20 and the second switch 216b. The second switch 216b controls the flow of the startup power signal 212 from the second switch 216b and the load 20 to ground.

Toggling the first and second switches 216a, b is used to convert the startup power signal 212 into a square wave AC signal (see FIG. 7) to be provided to the load 20 as the startup output signal 202. When the first switch 216a is closed and the second switch 216b is open, the positive voltage portion of the startup output signal 202 is provided to the load 20. When the first switch 216a is open and the second switch 216b is closed, the negative voltage portion of the startup output signal 202 is provided to the load 20. Thus, by toggling the first and second switches 216a, b, an entire square AC waveform may be generated and provided to the load 20. The first and second AC control signals 208a, b may be toggled such that the startup output signal 202 oscillates at a desired frequency. In one example, the desired frequency may be 50 or 60 Hz to correspond to the frequency of AC current provided by a mains source.

Once the load 20 verifies the startup output signal 202 is providing AC current, the current sensor 40 provides the feedback signal 42 to the microcontroller 100 indicating that the load 20 has begun taking current to drive its components (such as one or more LEDs). The microcontroller 100 then instructs the startup signal controller 206 to open both the first and second switches 216a, b, ceasing the generation of the startup output signal 202. Simultaneously, the microcontroller 100 provides a drive control signal 104 to the drive signal controller 218. In response, the drive signal controller 218 generates a DC control signal 220 to close the third switch 216c. By closing the third switch 216c, the drive power signal 224 is provided to the load 20 as the drive output signal 204, thus driving the components of the load 20 (such as one or more LEDs) with DC current.

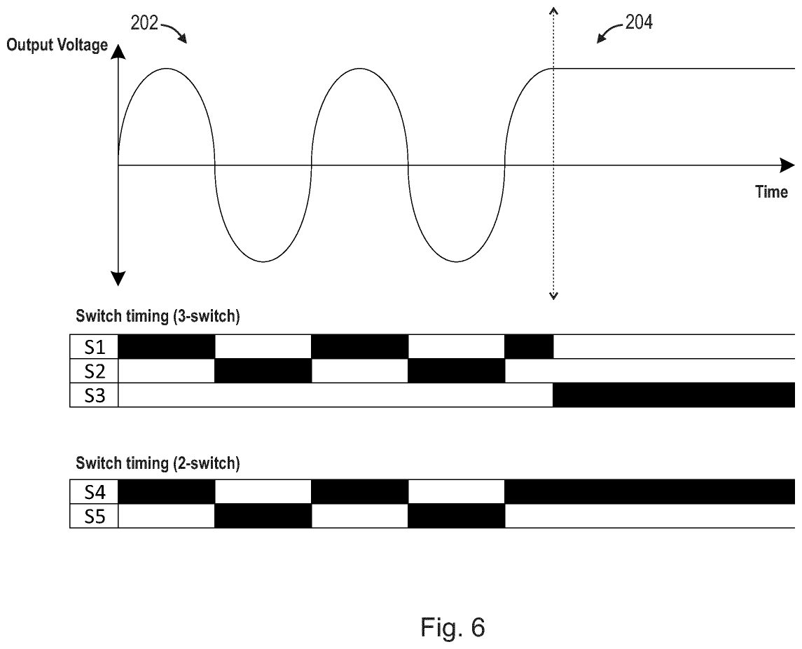

FIG. 4 is a variation of the driver circuit 10 of FIG. 2 wherein the startup signal generator 214 and the drive signal generator 218 include transistors 238a-c. While the transistors 238a-c are depicted as BJTs, other types of transistors, such as MOSFETs or IGBTs may be used. The transistors 238a-c may be used to generate a wider variety of waveform types for the startup output signal 202 and the drive output signal 204. The first and second transistors 238a, b are used to generate the startup output signal 202. In some examples, the first and second transistors 238a, b may be operated as “on/off” switches, resulting in the startup output signal 202 appearing as a square wave AC signal (see FIG. 6). Operating the transistors 238a, b in saturation mode may result in the transistors 238a, b behaving as switched-on switches. In other examples, the first and second transistors 238a, b may be operated in linear mode, resulting in the startup output signal 202 appearing as a sinusoidal or triangular AC signal. In this example, the first and second transistors 238a, b are arranged as an analog type-AB amplifier, though other amplifier configurations may be used where required.

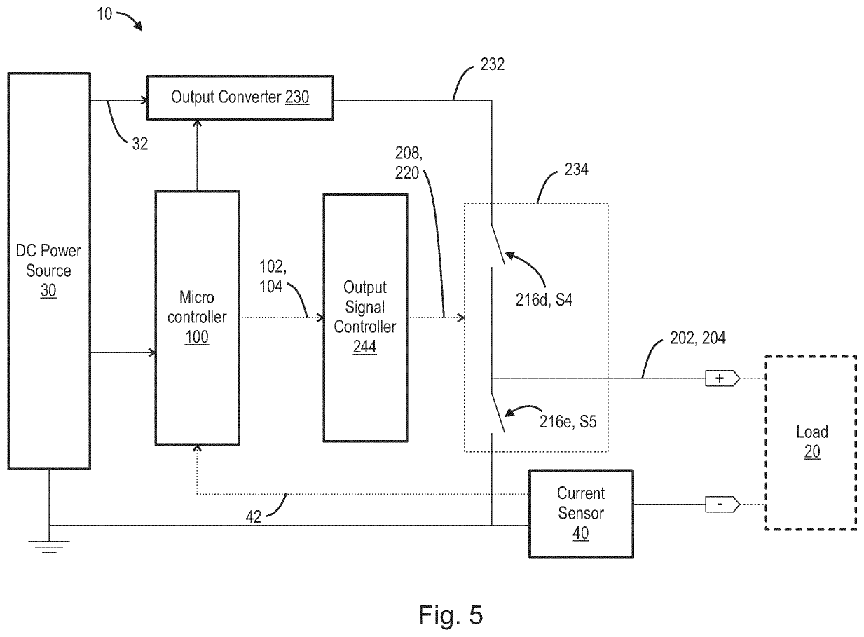

The third transistor 238c is used to provide the drive output signal 204 to the load 20. In some examples, the third transistor 238c may be operated as an “on/off” switch, resulting in the voltage-boosted drive power signal 224 being provided to the load 20 as the drive output signal 204. In other examples, the third transistor 238c may operate in linear mode, which may result in the drive output signal 204 being a rectified sinusoidal waveform. FIG. 5 illustrates a two-switch variation of the driver circuit 10 of FIG. 3. The driver circuit of FIG. 5 includes a microcontroller 100, an output signal controller 244, an output step-up DC-to-DC converter 230, and a universal signal generator 234. The universal signal generator 234 includes two switches 216d (S4), 216e (S5) used to generate both a startup output signal 202 and a drive output signal 204 depending on their configuration.

The output signal controller 244, in response to receiving the startup control signal 102 from the microcontroller 100, generates an AC control signal 208. The AC control signal 208 is provided to the universal signal generator 234. Simultaneously, the output step-up DC-to-DC converter 230 boosts the voltage of the DC power signal 32 provided by the DC power source 30 to a voltage level appropriate for both startup verification and drive modes of the load 20. In this example, the peak voltage of the startup output signal 202 will be equal to the voltage of the drive output signal 204. The output power signal 232 is provided to the universal signal generator 234 to generate the startup output signal 202 and drive output signal 204.

The AC control signal 208 is used by the universal signal generator 234 to toggle the two switches 216d (S4), 216e (S5). As with the driver circuit of FIG. 3, the fourth switch 216d controls the flow of the output power signal 232 to the load 20 and the fifth switch 216e. The fifth switch 216e controls the flow of the output power signal 232 from the fourth switch 216d and the load 20 to ground. When the fourth switch 216d is closed and the fifth switch 216e is open, the positive voltage portion of the startup output signal 202 is provided to the load 20. When the fourth switch 216d is open and the fifth switch 216e is closed, the negative voltage portion of the startup output signal 202 is provided to the load 20. Thus, by toggling the switches 216d, e, an entire square AC waveform (see FIG. 7) may be generated and provided to the load 20. In other examples, transistors 238 may be used instead of switches 216 if a sinusoidal (see FIG. 6) or triangular startup output signal 202 is required by the load 20.

Once the load 20 verifies the startup output signal 202 as providing AC current, the current sensor 40 provides the feedback signal 42 to the microcontroller 100 indicating that the load 20 has begun accepting current to drive its components (such as one or more LEDs). The microcontroller 100 then provides a drive control signal 104 to the output signal controller 244. In response to receiving the drive control signal 104, the output signal controller 244 provides a DC control signal 220 to the universal signal generator 234. The universal signal generator 234 then closes the fourth switch 216d and opens the fifth switch 216e, allowing the output power signal 232 to flow to the load 20 as the DC output power signal 204 to drive the components of the load 20 (such as one or more LEDs) with DC current.

FIG. 6 illustrates a switch timing diagram showing the variation of output voltage of startup output signals 202 and drive output signals 204 over time as generated by the driver circuits shown in FIGS. 3-5. In particular, as FIG. 6 shows a sinusoidal output voltage, S1-S5 are transistors, such as BJTs or MOSFETs. As shown in FIG. 6, in a three-switch configuration, the positive portion of an AC sine wave is provided to a load when S1 is operating in linear mode and S2 is open, and the negative portion of the AC sine wave is provided to a load when S1 is open and S2 is in linear mode, thus providing a startup output signal 202 oscillating according to the timing of switches S1 and S2. When a drive output signal 204 to drive the load is desired (such as when the load is accepting current), S1 and S2 are opened, and S3 is operated in saturation mode, resulting in a constant DC output voltage. Similarly, in a two-switch example, the positive portion of an AC sine wave is provided to a load when S1 is closed and S2 is open, and the negative portion of the AC sine wave is provided to a load when S1 is open and S2 is closed, resulting in a sinusoidal AC startup output signal 202. When a drive output signal 204 is desired, S1 closes and stays closed, while S2 is opened and stays open. In the example of FIG. 6, the peak voltage of the startup output signal 202 is presumed to equal the voltage level of the drive output signal 204.

FIG. 7 illustrates a square wave variation of the switching timing diagram of FIG. 5. In this variation, S1-S5 may be switches or transistors operated as switches. In FIG. 7, the positive portion of an AC sine wave is provided to a load when S1 or S4 are closed and S2 or S5 are open, and the negative portion of the AC sine wave is provided to a load when S1 or S4 are open and S2 or S5 are closed. When a drive output signal 204 to drive the load is desired (such as when the load is accepting current) in the three-switch example, S1 and S2 are open, and S3 is held closed. Alternatively, when a drive output signal 204 to drive the load is desired in the two-switch example, S4 is held closed while S5 is open.

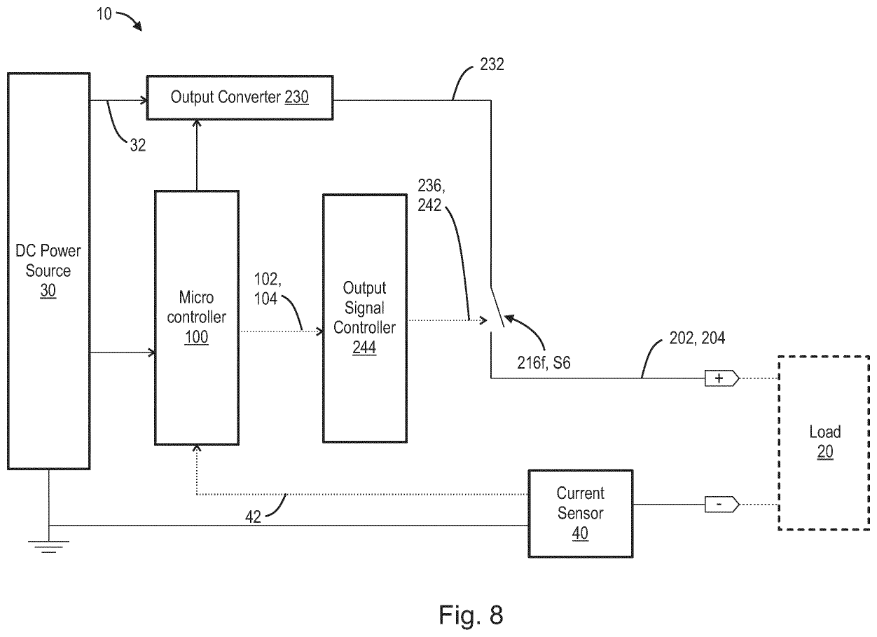

FIG. 8 is a one-switch variation of the driver circuit 10 of FIG. 3, according to aspects of the present disclosure. In the examples of FIG. 7, the load 20 is configured with a different startup routine than the previous examples. Rather than detecting AC voltage, the load 20 detects a pattern of DC voltage (such as a pulsed square wave or rectified sine wave) before being continuously driven by a steady DC voltage. The microcontroller 100 provides the output signal controller 244 with a startup control signal 102. In response to receiving the startup control signal 102, the output signal controller 244 generates a startup switching signal 236 corresponding to the startup routine required by the load 20. The startup switching signal 236 causes a switch 216f to open and close according to the startup routine of the load 20. In some examples, the switch 216f may be a transistor. Thus, the load 20 is provided with a startup output signal 202 with a peak voltage level corresponding to the output power signal 232 (generated by the output step-up DC-to-DC power converter 230) with switch timing corresponding to the startup switching signal 236.

As with the previous examples, a feedback signal 42 is provided by the current sensor 40 to the microcontroller 100 indicating that the load 20 has begun accepting current to drive its components. In response, the microcontroller 100 provides a drive control signal 104 to the output signal controller 244. The output signal controller 244 then provides the switch 216f with a drive switching signal 242 to close the switch 216f. Closing the switch 216f allows the output power signal 232 to be provided to the load 20 as a drive output signal 204 with a steady DC voltage.

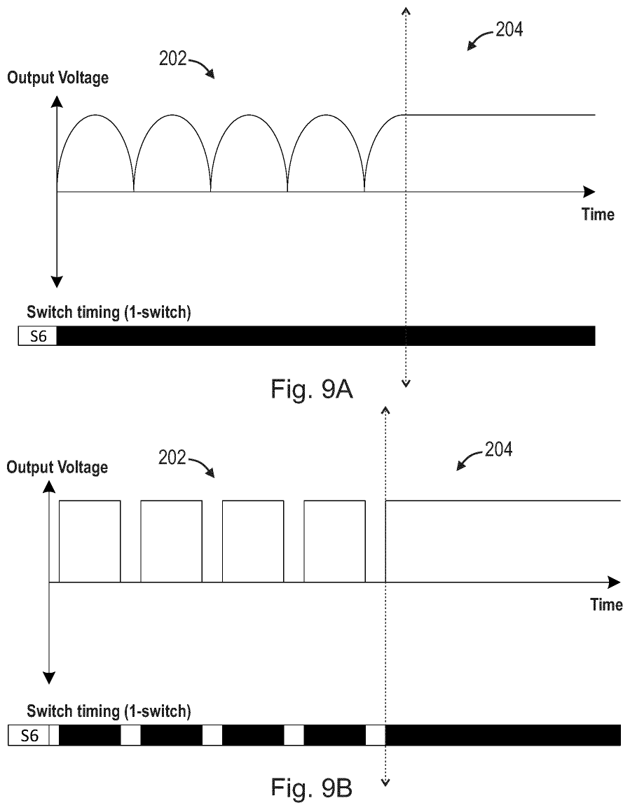

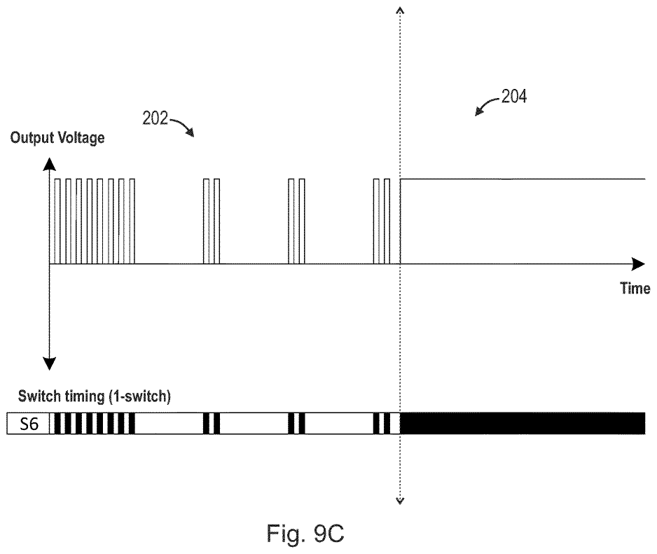

FIGS. 9A-9C illustrate switch timing diagrams showing the variation of output voltage over time of the driver circuit shown in FIG. 8. In particular, as FIG. 9A shows a rectified sinusoidal startup output voltage 202, S6 is a transistor, such as a BJT or MOSFET. During startup, S6 is operated in linear mode to generate the sinusoidal waveform. When a drive output signal 204 to drive the load is desired (such as when the load is accepting current), S6 is operated in saturation mode, resulting in a constant DC output voltage.

FIG. 9B illustrates a DC square wave variation of the switching timing diagram of FIG. 9A. In this variation, S6 may be a switch or a transistor operated as a switch. The square wave startup output signal 202 is generated by opening and closing S6. When a drive output signal 204 is desired to drive the load, S6 is held closed for a constant DC output voltage.

FIG. 9C illustrates a pulsed DC variation of the switching timing diagram of FIGS. 9A and 9B. In this variation, S6 may be a switch or a transistor operated as a switch.

The pulsed DC startup output signal 202 is generated by opening and closing S6 according to the desired pulse timing scheme. When a drive output signal 204 is desired to drive the load, S6 is held closed for a constant DC output voltage.

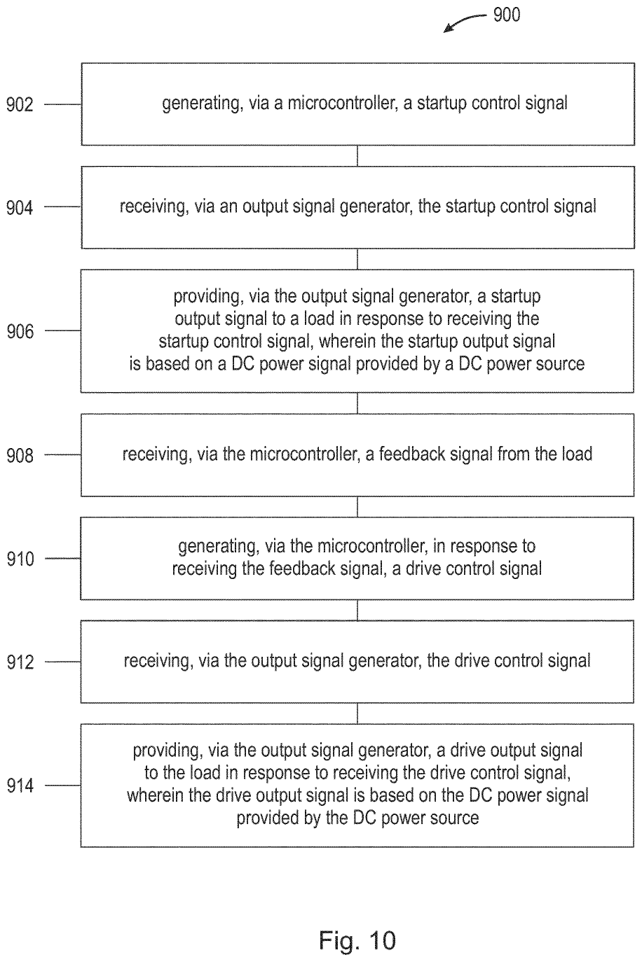

FIG. 10 illustrates a flowchart of a method 900 for driving a load. The method 900 includes generating 902, via a microcontroller, a startup control signal. The method 900 further includes receiving 904, via an output signal generator, the startup control signal. The method 900 further includes providing 906, via the output signal generator, a startup output signal to a load in response to receiving the startup control signal. The startup output signal is based on a DC power signal provided by a DC power source. The method 900 further includes receiving 908, via the microcontroller, a feedback signal corresponding to the load. The method 900 further includes generating 910, via the microcontroller, in response to receiving the feedback signal, a drive control signal. The method 900 further includes receiving 912, via the output signal generator, the drive control signal. The method 900 further includes providing 914, via the output signal generator, a drive output signal to the load in response to receiving the drive control signal. The drive output signal is based on the DC power signal provided by the DC power source.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects can be implemented using hardware, software, or a combination thereof. When any aspect is implemented at least in part in software, the software code can be executed on any suitable processor or collection of processors, whether provided in a single device or computer or distributed among multiple devices/computers.

The present disclosure can be implemented as a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some examples, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions can be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions can also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific examples described herein. It is, therefore, to be understood that the foregoing examples are presented by way of example only and that, within the scope of the appended claims and equivalents thereto, examples can be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A driver circuit configured to use a DC power signal provided by a DC power source to drive a Type & TLED load, comprising:
a microcontroller configured to generate a startup control signal; and
an output signal generator configured to:
receive the startup control signal;
convert the startup control signal into a startup, wherein the startup output signal is configured to provide verification of a presence of an AC current to the Type B TLED load;
wherein the microcontroller is further configured to:
receive a feedback signal corresponding to the Type B TLED load; and
generate, in response to receiving the feedback signal, a drive control signal; and
wherein the output signal generator is further configured to:
receive the drive control signal; and
provide a drive output signal to drive the Type B TLED load, wherein the drive output signal is based on the DC power signal provided by the DC power source.

2. (canceled)

3. (canceled)

4. The driver circuit of claim 1, wherein the DC power source is a battery.

5. The driver circuit of claim 1, wherein the startup output signal is a sinusoidal waveform, a square waveform, or a triangular waveform.

6. The driver circuit of claim 1, wherein the output signal generator comprises:
a startup signal controller configured to generate an AC control signal in response to receiving the startup control signal;
a startup step-up DC-to-DC converter configured to generate a startup power signal based on the DC power signal; and
a startup signal generator configured to generate, in response to receiving the AC control signal, the startup output signal based on the startup power signal.

7. The driver circuit of claim 6, wherein the startup signal generator comprises one or more switches or transistors.

8. The driver circuit of claim 6, wherein the startup signal generator is an analog type-AB amplifier.

9. The driver circuit of claim 6, wherein the output signal generator further comprises:
a drive signal controller configured to generate a DC control signal in response to receiving the drive control signal;
a drive step-up DC-to-DC converter configured to generate a drive power signal based on the startup power signal; and
a drive signal generator configured to provide, in response to receiving the DC control signal, the drive output signal wherein the drive output signal corresponds to the drive power signal.

10. The driver circuit of claim 9, wherein the drive signal generator is a switch or a transistor.

11. The driver circuit of claim 1, wherein the output signal generator comprises:
an output signal controller configured generate an AC control signal in response to receiving the startup control signal;
an output step-up DC-to-DC converter configured to generate an output power signal based on the DC power signal and
a universal signal generator configured to generate, in response to receiving the AC control signal, the startup output signal based on the output power signal.

12. The driver circuit of claim 11, wherein:
the output signal controller is further configured to generate a DC control signal in response to receiving the drive control signal; and
the universal signal generator is further configured to generate, in response to receiving the DC control signal, the drive output signal based on the output power signal.

13. The driver circuit of claim 1, wherein the microcontroller is configured to generate the startup control signal upon activation.

14. The driver circuit of claim 1, wherein the startup output signal is an AC signal, and the drive output signal is a DC signal.

15. A method for driving a Type B TLED load using a DC power signal provided by a DC power source comprising:
generating, via a microcontroller, a startup control signal;
receiving, via an output signal generator, the startup control signal;
converting the startup control signal into a startup output signal, wherein the startup output signal is configured to provide verification of a presence of an AC current to the Type B TLED load;
receiving, via the microcontroller, a feedback signal corresponding to the Type B TLED load;
generating, via the microcontroller, in response to receiving the feedback signal, a drive control signal;
receiving, via the output signal generator, the drive control signal; and
providing, via the output signal generator, a drive output signal to drive the Type B TLED load in response to receiving the drive control signal, wherein the drive output signal is based on the DC power signal provided by the DC power source.
